(19) United States
(12) Patent Application Publication
(10) Pub. No.: US 2021/0297551 A1
(43) Pub. Date: Sep. 23, 2021

(54) IMAGE FORMING APPARATUS, INFORMATION PROCESSING METHOD, AND NON-TRANSITORY RECORDING MEDIUM

(71) Applicant: Takuya OKAMOTO, Kanagawa (JP)

(72) Inventor: Takuya OKAMOTO, Kanagawa (JP)

(73) Assignee: Ricoh Company, Ltd., Tokyo (JP)

(21) Appl. No.: 17/196,468

(22) Filed: Mar. 9, 2021

(30) Foreign Application Priority Data
Mar. 19, 2020 (JP) 2020-050239

(51) Int. Cl. H04N 1/21; H04N 1/00; H04N 1/44

(52) U.S. Cl. CPC H04N 1/2183; H04N 1/00209; H04N 2201/0094; H04N 1/444; H04N 2201/3205; H04N 1/00408

(57) ABSTRACT

An image forming apparatus includes circuitry configured to receive facsimile data; extract, from a storage area, a folder satisfying an extraction condition; display a folder list screen including at least an extracted folder list listing the extracted folder; receive selecting of a folder from the extracted folder list; and set the selected folder as a sorting folder for storing the received facsimile data.

### CROSS-REFERENCE TO RELATED APPLICATION

This patent application is based on and claims priority pursuant to 35 U.S.C. § 119(a) to Japanese Patent Application No. 2020-050239, filed on Mar. 19, 2020, in the Japan Patent Office, the entire disclosure of which is hereby incorporated by reference herein.

### BACKGROUND

### Technical Field

The present disclosure relates to an image forming apparatus, an information processing method, and a non-transitory recording medium.

### Related Art

For example, many multifunction peripherals (MFPs) have a storing capability to store received facsimile data in a facsimile reception folder in the MFP, to be paperless. In some cases, the facsimile reception folder for storing the facsimile data is divided for a plurality of particular senders, and the storing capability includes a sorting folder capability (hereinafter may be referred to as “sorting folder function”) to sort the received facsimile data (e.g., facsimile documents) into the folders divided corresponding to senders.

### SUMMARY

According to an embodiment of the present disclosure, an image forming apparatus includes circuitry configured to receive facsimile data; extract, from a storage area, a folder satisfying an extraction condition; and display a folder list screen including at least an extracted folder list listing the extracted folder. The circuitry is further configured to receive selecting of a folder from the extracted folder list, and set the selected folder as a sorting folder for storing the received facsimile data.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a general arrangement of a system according to an embodiment of the present disclosure, in which a multifunction peripheral (MFP) receives facsimile data;

FIG. 2 is a block diagram illustrating an example of a hardware configuration of the MFP of the system illustrated in FIG. 1;

FIG. 3 is a block diagram illustrating an example of a functional configuration of the MFP illustrated in FIG. 2;

FIG. 4 illustrates an example of a folder management table;

FIG. 5 illustrates an example of a sorting condition management table;

FIG. 6 is a diagram schematically illustrating an example of an operation of displaying a list of folders having a name including a sender name;

FIG. 7 is a diagram schematically illustrating an example of an operation of displaying a list of password-protected folders;

FIG. 8 is a diagram illustrating an example of a folder list screen;

FIG. 9 is a diagram illustrating an example of a folder creation screen;

FIG. 10 is a sequence chart illustrating an example of a sorting folder setting operation performed by the MFP illustrated in FIG. 3;

FIG. 11 is a diagram illustrating an example of a sorting folder registration screen;

FIG. 12 is a flowchart illustrating an example of operation of extracting a folder satisfying a designated extraction condition, performed in the sorting folder setting operation illustrated in FIG. 10;

FIG. 13 is a diagram illustrating an example of an extracted folder list screen;

FIG. 14 is a flowchart illustrating another example of operation of extracting a folder satisfying a designated extraction condition, performed in the sorting folder setting operation;

FIG. 15 is a diagram illustrating another example of the extracted folder list screen;

FIG. 16 is a sequence chart illustrating an example of facsimile reception operation performed by the MFP illustrated in FIG. 3; and

FIG. 17 illustrates an example of a display priority setting table.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a,” “an,” and “the” are intended to include the plural forms as well, unless the context clearly indicates otherwise.

Hereinafter, an image forming apparatus, an information processing apparatus, an information processing method, and a program according to the present disclosure are described in detail with reference to the accompanying drawings. The present disclosure, however, is not limited to the following one or more embodiments, and elements of the following one or more embodiments include elements that may be easily conceived by those skilled in the art, those being substantially the same ones, and those being within equivalent ranges. Furthermore, various omissions, substitutions, changes and combinations of the constituent elements may be made without departing from the gist of the following one or more embodiments.

In the description of one or more embodiments given below, the following terms are defined or have meaning as described below. Computer software, which may be, hereinafter, simply referred to as “software,” is defined as a program related to operation of a computer or any data to be used in processing performed by a computer according to such a program. “Application software,” which may be simply referred to as an “application,” is a general term for any software used to perform certain processing. “Operating system (OS),” which is hereinafter simply referred to as an “OS,” is software for controlling a computer, such that software, such as application software, is able to use computer resources. The operating system controls the computer and performs basic operation and management, such as input or output of data, management of hardware resources such as a memory or a hard disk, and management of processes. Application software operates by utilizing functions provided by the operating system. “Program” is defined as a set of instructions for causing a computer to perform processing to have a certain result. Data or an instruction that is not a direct command to a computer is not a program itself. However, data that defines processing to be performed by the program is interpreted as equivalent to the program. For example, a data structure, which is a logical structure of data represented by an interrelation between data elements, may be interpreted as equivalent to the program.

In the embodiments described below, an information processing apparatus receives facsimile data from a sender apparatus. Examples of the information processing apparatus include an image forming apparatus such as an MFP, a standard facsimile receiver, and a personal computer (PC), and the present embodiment is described using the MFP. The term “MFP” refers to an image forming apparatus having at least two of copying, printing, scanning, and facsimile functions.

Configuration of System including MFP

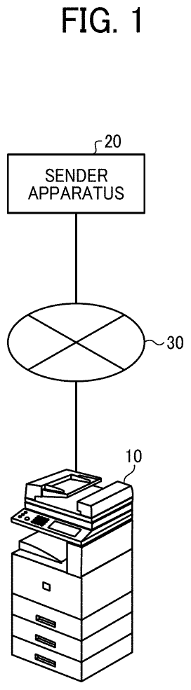

FIG. 1 is a diagram illustrating an example of a general arrangement of the system according to the present embodiment, in which the MFP receives facsimile data. A description is given below of the general arrangement of the system according to the present embodiment, in which an MFP 10 receives the facsimile data, with reference to FIG. 1.

The MFP 10 illustrated in FIG. 1 is an image forming apparatus that receives facsimile data from a sender apparatus 20 via a public network 30. The sender apparatus 20 is a facsimile transmission machine that transmits facsimile data to the MFP 10 via the public network 30, and is, for example, owned by a business partner of a company that owns the MFP 10. The sender apparatus 20 is assumed to be an MFP, a standard facsimile receiver, a PC, or the like. The sender apparatus 20 is an example of the machine from which the MFP 10 receives the facsimile data. Needless to say, there is a machine that transmits facsimile data to the MFP 10.

The public network 30 is, for example, an analog line or a digital line such as the integrated services digital network (ISDN).

Hardware Configuration of MFP

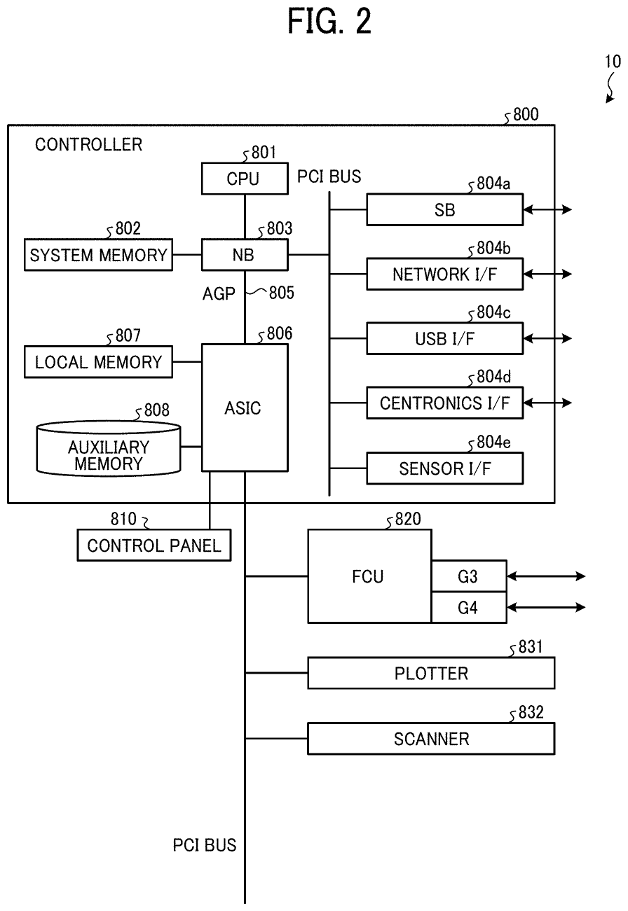

FIG. 2 is a block diagram illustrating an example of a hardware configuration of the MFP 10 according to the present embodiment. The hardware configuration of the MFP 10 according to the present embodiment is described below with reference to FIG. 2.

As illustrated in FIG. 2, the MFP 10 includes a controller 800, a control panel 810, a facsimile control unit (FCU) 820, a plotter 831, and a scanner 832 that are connected by a peripheral component interconnect (PCI) bus.

The controller 800 is a device that controls the entire operation, drawing, and communication performed by the MFP 10 and controls input from the control panel 810.

The control panel 810 is, for example, a touch panel. The control panel 810 is a device that receives an input to the controller 800 (input function) and displays the status of the MFP 10 (display function). The control panel 810 is directly connected to an application-specific integrated circuit (ASIC) 806 described later.

The FCU 820 is a device that provides a facsimile function, and is connected to the ASIC 806 via, for example, the PCI bus.

The plotter 831 is a device that provides a printing function, and is connected to the ASIC 806 via, for example, the PCI bus. The scanner 832 provides a scanner function, and is connected to the ASIC 806 via, for example, the PCI bus.

The controller 800 includes a central processing unit (CPU) 801, a system memory 802, a north bridge (NB) 803, a south bridge (SB) 804a, a network interface (I/F) 804b, a universal serial bus (USB) I/F 804c, a Centronics I/F 804d, a sensor I/F 804e, the ASIC 806, a local memory 807, and an auxiliary memory 808.

The CPU 801 controls the entire operation of MFP 10. The CPU 801 is connected to a chipset including the system memory 802, the north bridge 803, and the south bridge 804a, and is connected to other devices via the chipset.

The system memory 802 is a memory for, for example, storing programs and data, loading programs and data, and storing drawing data of a printer. The system memory includes a read only memory (ROM) and a random access memory (RAM). The ROM is a read-only memory for storing programs and data. the RAM is a writable and readable memory for, for example, loading programs and data, and storing drawing data of the printer. The north bridge 803 is a bridge for connecting the CPU 801 to the system memory 802, the south bridge 804a, and an Accelerated Graphics Port (AGP) bus 805. The north bridge 803 includes a memory controller that controls reading from and writing to the system memory 802, a PCI master, and an AGP target.

The SB 804a serves as a bridge between the NB 803 and PCI devices and peripheral devices. The south bridge 804a is connected to the north bridge 803 via the PCI bus. The network I/F 804b, the USB I/F 804c, the Centronics I/F 804d, and the sensor I/F 804e are connected to the PCI bus.

The AGP bus 805 is a bus interface for graphics accelerator cards to accelerate graphics processing. The AGP bus 805 can speed up the graphics accelerator card by directly accessing the system memory 802 with high throughput.

The ASIC 806 is an integrated circuit (IC) for image processing applications having hardware elements for image processing. The ASIC 806 serves as a bridge that connects the AGP bus 805, the PCI bus, the auxiliary memory 808, and the local memory 807 with each other. The ASIC 806 includes a PCI target, an AGP master, an arbiter (ARB) that is the core of the ASIC 806, a memory controller that controls the local memory 807, a plurality of direct memory access controllers (DMACs) that, for example, rotate image data by hardware logic, and a PCI unit that transfers data between the plotter 831 and the scanner 832 via the PCI bus. For example, the FCU 820, the plotter 831 and the scanner 832 are connected to the ASIC 806 via the PCI bus.

The local memory 807 is a memory used as a copy image buffer and a code buffer.

The auxiliary memory 808 is a storage area such as a hard disk drive (HDD), a solid state drive (SSD), a Secure Digital (SD) card, or flash memory, and stores image data, programs, font data, and forms.

The hardware configuration of the MFP 10 illustrated in FIG. 2 is an example. The MFP 10 may omit some of the components illustrated in FIG. 2 or include one or more components.

Functional Configuration of MFP

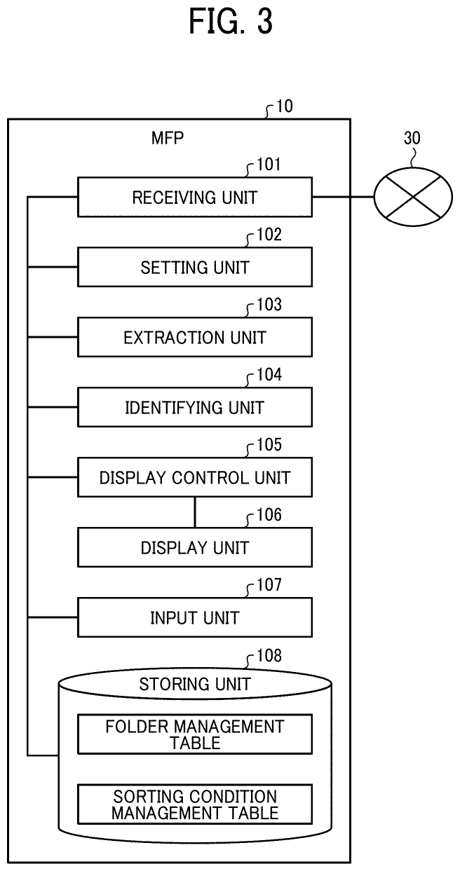

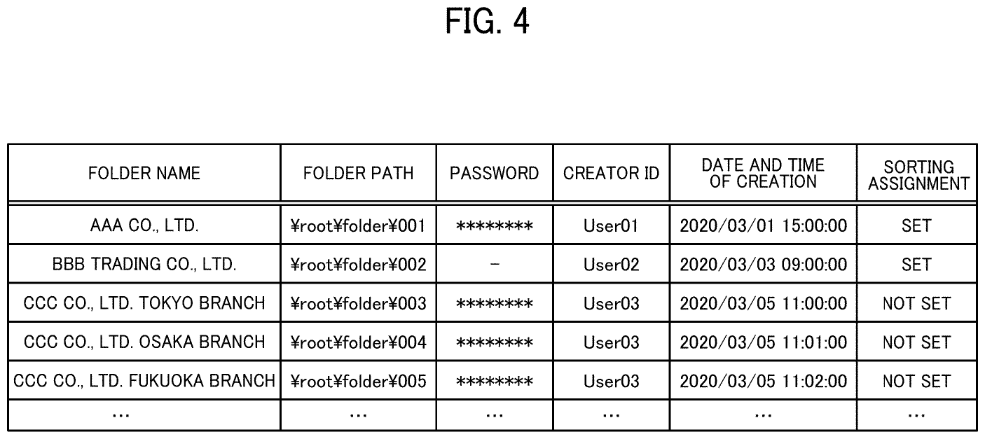

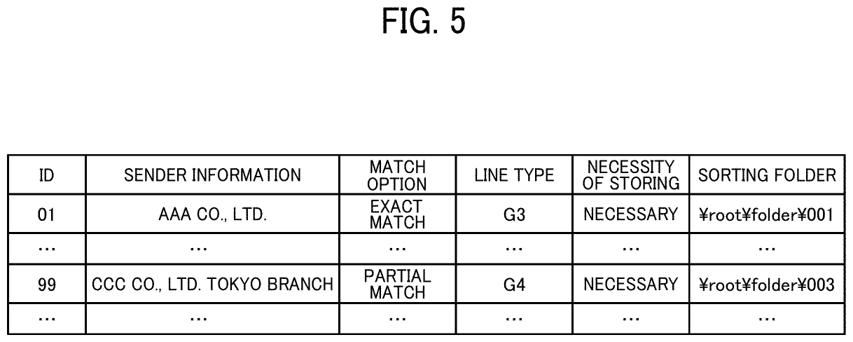

FIG. 3 is a diagram illustrating an example of the functional configuration of the MFP 10 according to the present embodiment. FIG. 4 illustrates an example of a folder management table. FIG. 5 illustrates an example of a sorting condition management table. Descriptions are given below of the functional configuration and operation of the MFP 10 according to the present embodiment, with reference to FIGS. 3 to 5.

As illustrated in FIG. 3, the MFP 10 includes a receiving unit 101, a setting unit 102, an extraction unit 103, an identifying unit 104, a display control unit 105, a display unit 106, an input unit 107, and a storing unit 108.

The receiving unit 101 is a functional unit that receives facsimile data from an external device (e.g., the sender apparatus 20) via the public network 30. Further, the receiving unit 101 extracts the sender identification information (for example, the facsimile number of the sender or the name of the sender apparatus) identifying the sender from the received facsimile data. The receiving unit 101 is implemented by the program executed by the CPU 801 illustrated in FIG. 2 and the FCU 820.

The setting unit 102 is a functional unit that manages and controls the setting operation on a folder list screen 1000 and a sorting folder registration screen 1200, the descriptions thereof are deferred. The setting unit 102 is implemented by, for example, a program executed by the CPU 801 illustrated in FIG. 2.

The extraction unit 103 is a functional unit that extracts a folder that satisfies the conditions set on the sorting folder registration screen 1200, the descriptions thereof is deferred, from a list of all folders. The extraction unit 103 is implemented by, for example, a program executed by the CPU 801 illustrated in FIG. 2.

The identifying unit 104 is a functional unit that identifies, in a sorting condition management table, a sorting folder record (sorting folder information) corresponding to sender identification information of the facsimile data received by the receiving unit 101. The sorting condition management table is stored in the storing unit 108 as illustrated in FIG. 5. The identifying unit 104 acquires the path of the sorting folder from the identified sorting folder information. The identifying unit 104 is implemented by, for example, a program executed by the CPU 801 illustrated in FIG. 2.

The display control unit 105 is a functional unit that controls display operation of the display unit 106. The display control unit 105 is implemented by, for example, a program executed by the CPU 801 illustrated in FIG. 2.

The display unit 106 is a functional unit that displays various screens under control of the display control unit 105. The display unit 106 is implemented by the display function of the control panel 810 illustrated in FIG. 2.

The input unit 107 is a functional unit that receives an input operation performed by a user. The input unit 107 is implemented by the input function of the control panel 810 illustrated in FIG. 2.

The storing unit 108 is a functional unit that stores various types of information. The storing unit 108 stores, for example, the folder management table illustrated in FIG. 4 and the sorting condition management table illustrated in FIG. 5. The storing unit 108 further stores (accumulates) the facsimile data received by the receiving unit 101 in the set sorting folder. The storing unit 108 is implemented by the auxiliary memory 808 illustrated in FIG. 2.

The folder management table illustrated in FIG. 4 is a table that manages folders created in the storing unit 108 (the auxiliary memory 808). As illustrated in FIG. 4, the folder management table stores, in association with each other, the folder name of the folder, the path where the folder is created (folder path), the password assigned to the folder, a creator identifier (ID) identifying the creator of the folder, the date and time of creation of the folder, and the presence or absence of sorting assignment indicating whether or not the folder has been set as the sorting folder. For example, in FIG. 4, the folder name “CCC Co., Ltd. Tokyo Branch,” the folder path “¥root¥folder¥003,” a password “********,” the creator ID “User03,” the creation date and time “2020/03/05 11:00:00,” and the sorting assignment “not set” are associated with each other.

The sorting condition management table illustrated in FIG. 5 is a table for determining and registering a sorting folder, into which the received facsimile data is sorted, for each sender. As illustrated in FIG. 5, the sorting condition management table stores an ID identifying each record, sender information identifying the sender, a match option as a search option for extracting the sorting folder using the sender information, a line type indicating the type of facsimile line, the necessity of storing facsimile data, and the sorting folder path that is the path of the sorting folder to which the facsimile data is sorted. For example, in FIG. 5, the ID “01” is associated with the sender information “AAA Co., Ltd.,” the match option “exact match”, the line type “G3,” the necessity of storing “necessary,” and the sorting folder path “¥root¥folder¥ 001.”

The setting unit 102, the extraction unit 103, the identifying unit 104, and the display control unit 105 described above are implemented by execution of a software program, but the implementation is not limited thereto. Alternatively, at least one of those functional units may be implemented by a dedicated hardware circuit (an integrated circuit or the like).

Each functional unit of the MFP 10 illustrated in FIG. 3 is a conceptual function, and the functional configuration of the MFP 10 is not limited thereto. For example, a plurality of functional units of the MFP 10 illustrated as independent units in FIG. 3 may be integrated into a single functional unit. On the other hand, in the MFP 10 illustrated in FIG. 3, one function may be divided into a plurality of functions, and one functional unit may be divided into a plurality of functional units.

Extraction of Folder and Display of Extracted Folder List

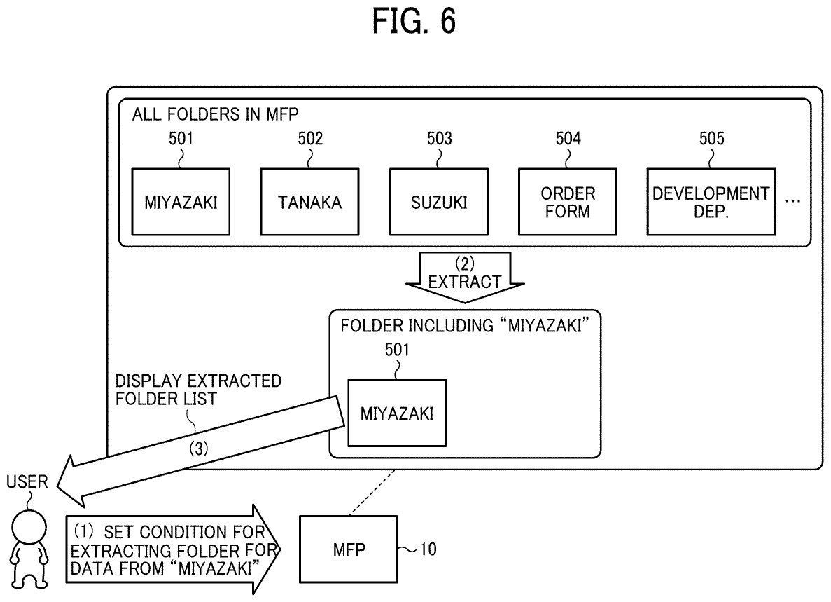

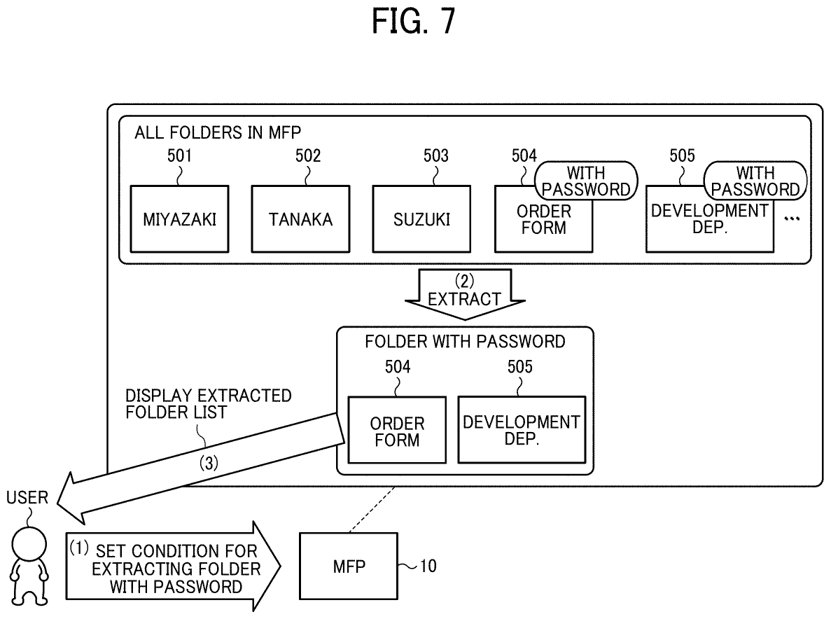

FIG. 6 is a diagram illustrating an outline of an operation of displaying a list of folders including a sender name. FIG. 7 is a diagram illustrating an outline of an operation of displaying a list of folders protected with a password. With reference to FIGS. 6 and 7, a description is given of the outline of the operation, performed by the MFP 10, of extracting the folders satisfying the extraction condition and displaying a list of extracted folders according to the present embodiment.

FIG. 6 illustrates an operation of extracting a folder on condition that the folder name includes the sender name and displaying a list of folders that are candidates for the folder to which the facsimile data is sorted. The example illustrated in FIG. 6 is on the assumption that the memory of the MFP 10 includes five folders 501 to 505 created in the storing unit 108. As illustrated in FIG. 6, the folder name of the folder 501 is “Miyazaki,” the folder name of the folder 502 is “Tanaka,” the folder name of the folder 503 is “Suzuki,” the folder of the folder 504 is “order form,” and the folder name of folder 505 is “development dept.”

First, in order to set the sorting folder into which facsimile data from a particular sender indicated as “Miyazaki,” on the MFP 10, the user performs an operation for extracting a folder on condition that the folder name includes “Miyazaki” (for example, including “Miyazaki” converted into Kanji and that converted into hiragana) as (1) in FIG. 6. For example, the user sets such an extraction condition to the MFP 10.

Then, the MFP 10 searches the folders 501 to 505 created in the storing unit 108 for a folder having a name including “Miyazaki,” and extracts the folder 501 having the name “Miyazaki” as the corresponding folder as (2) in FIG. 6.

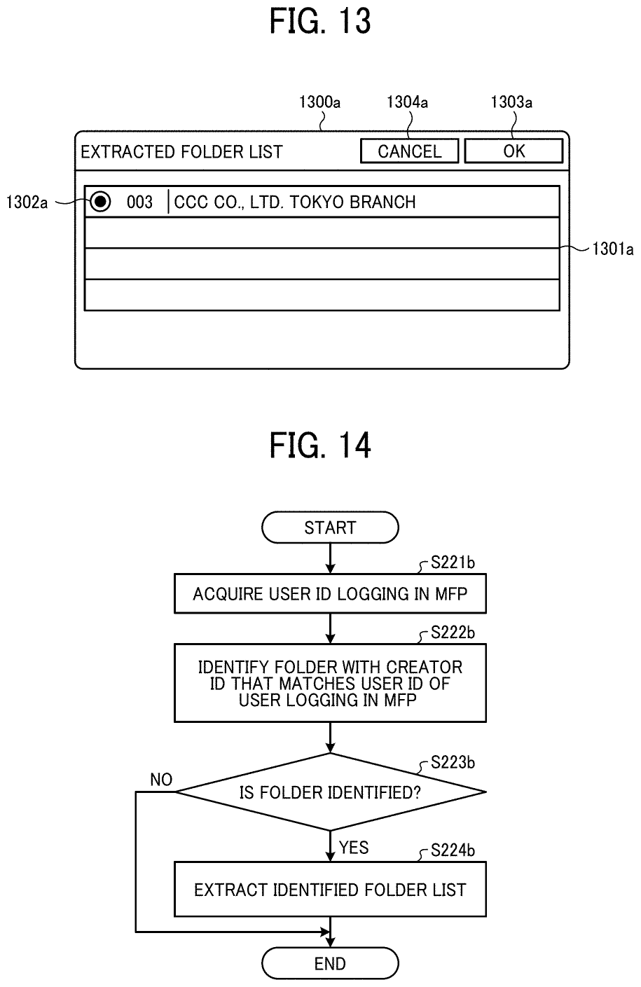

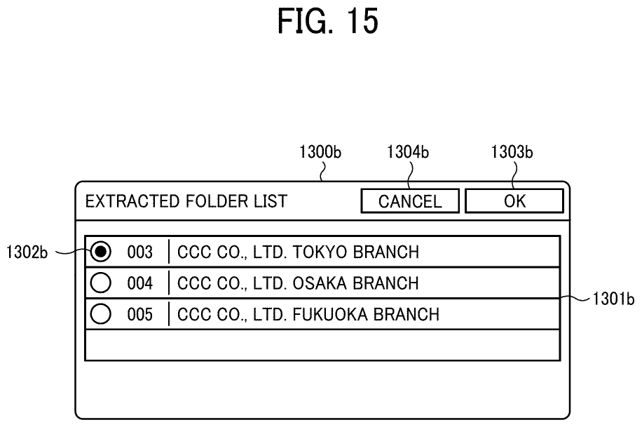

Then, the MFP 10 displays an extracted folder list listing the folder 501 in this example as the folder satisfying the extraction condition on the extracted folder list screen (see FIGS. 13 and 15 described later) as (3) in FIG. 6.

This configuration can allow the user to select the facsimile data sorting folder from, instead of all the folders in the storing unit 108, the list of folders extracted according to the extraction conditions designated by the user. Thus, this configuration can facilitate setting of the folder to which the facsimile data is sorted.

Further, FIG. 7 illustrates an operation of extracting a folder on condition that the folder is protected with a password and displaying a list of folders that are candidates for the folder to which the facsimile data is sorted. Similar to FIG. 6, the example illustrated in FIG. 7 is on the assumption that the memory of the MFP 10 includes the five folders 501 to 505 created in the storing unit 108 (the auxiliary memory 808).

First, the user performs, on the MFP 10, an operation for extracting the folder on condition that the folder is protected with a password as (1) in FIG. 7.

Then, the MFP 10 searches the folders 501 to 505 created in the storing unit 108 for a folder protected with a password and extracts the folder 504 having the name “order form” and the folder 505 having the name “development dept” as the corresponding folders as (2) in FIG. 7.

Then, the MFP 10 displays an extracted folder list listing the folders 504 and 505 in this example as folders satisfying the extraction condition, on the extracted folder list screen (see FIGS. 13 and 15 described later) as (3) of FIG. 7.

This configuration also can allow the user to select the facsimile data sorting folder from, instead of all the folders in the storing unit 108, the list of folders extracted according to the extraction condition designated by the user. Thus, this configuration can facilitate setting of the folder to which the facsimile data is sorted.

Creation of New Folder

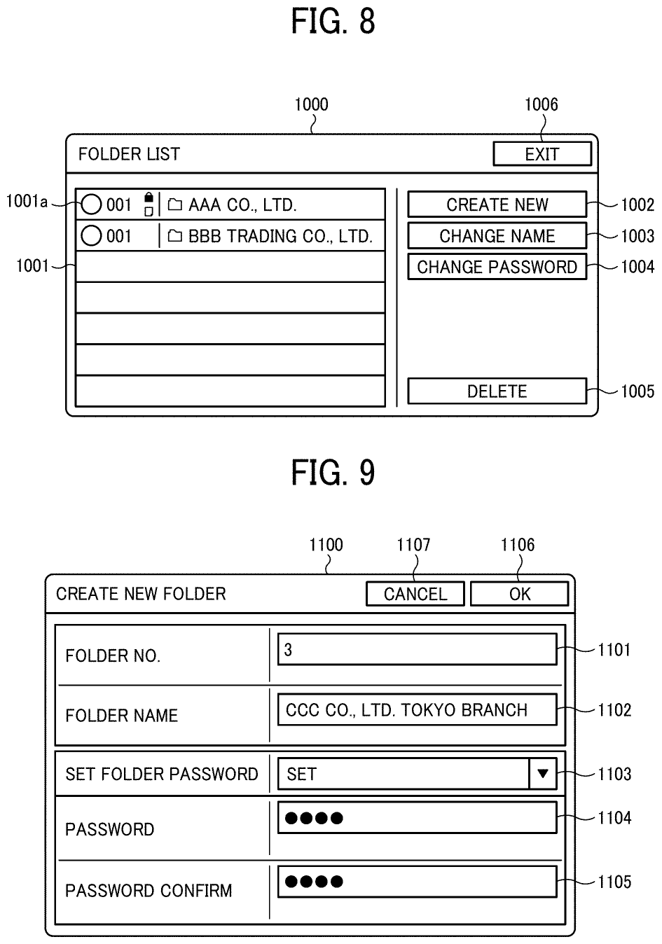

FIG. 8 is a diagram illustrating an example of the folder list screen. FIG. 9 is a diagram illustrating an example of a folder creation screen. Referring to FIGS. 8 and 9, a description is given of an operation of creating a new folder in the MFP 10 according to the present embodiment.

The folder list screen 1000 illustrated in FIG. 8 is for displaying a list of folders already created in the storing unit 108 (the auxiliary memory 808) of the MFP 10. The folder list screen 1000 is displayed by the display unit 106 (the control panel 810). As illustrated in FIG. 8, the folder list screen 1000 includes a folder list display area 1001, a folder creation button 1002 (labelled “create new”), a name change button 1003 (labelled “change name”), a password change button 1004 (labelled “change password”), a delete button 1005, and an exit button 1006.

The folder list display area 1001 is a display area for displaying a list of folders already created in the storing unit 108 (the auxiliary memory 808). Each folder displayed in the folder list display area 1001 is provided with a radio button 1001a. The user can operate the radio button 1001a to select the folder corresponding to the radio button 1001a. The folder creation button 1002 is a button to be pressed for creating a new folder.

The name change button 1003 is a button for changing the folder name of the selected folder. The password change button 1004 is a button for changing the password set to the selected folder. The delete button 1005 is a button for deleting the selected folder. The exit button 1006 is a button for exiting the folder list screen 1000.

When the user presses the folder creation button 1002 to create a new folder, the display control unit 105 of the MFP 10 controls the display unit 106 to display a new folder creation screen 1100 illustrated in FIG. 9. The new folder creation screen 1100 illustrated in FIG. 9 is a screen for setting various attribute information about a newly created folder. As illustrated in FIG. 9, the new folder creation screen 1100 includes a folder number input field 1101, a folder name input field 1102, a password setting option field 1103, a password input field 1104, a password confirmation input field 1105, an OK button 1106 (create button), and cancel button 1107.

The folder number input field 1101 is a field for inputting the identification number of a newly created folder. The folder name input field 1102 is a field for inputting the name of the newly created folder. The password setting option field 1103 is a combo box for setting whether or not to set a password for the newly created folder. The password input field 1104 is a field for inputting a password to be set to the newly created folder when “set” is selected in the password setting option field 1103. The password confirmation input field 1105 is a field for again inputting the password in order to confirm the password input in the password input field 1104.

The OK button 1106 is a button for creating a new folder based on the attribute information input to the folder number input field 1101, the folder name input field 1102, the password setting option field 1103, the password input field 1104, and the password confirmation input field 1105. The cancel button 1107 is a button for canceling the creation of the new folder.

The user inputs information into the folder number input field 1101, the folder name input field 1102, the password setting option field 1103, the password input field 1104, and the password confirmation input field 1105, and presses the OK button 1106. Then, the setting unit 102 of the MFP 10 newly creates a folder in the storing unit 108 based on the input attribute information. Further, the setting unit 102 registers, in the folder management table illustrated in FIG. 4, as information for managing the created folder, the folder name input to the folder name input field 1102, the folder path designated by the number input to the folder number input field 1101, the password input in the password input field 1104 (and the password confirmation input field 1105), the ID (the creator ID) of the user logging in the MFP 10, and the date and time of creation of the new folder in association with each other, thereby registering a new record. Further, the setting unit 102 registers “not set” as the sorting assignment for the registered record.

With the above operation, a new folder is created, and the attribute information of the folder is registered in the folder management table illustrated in FIG. 4.

Sorting Folder Setting

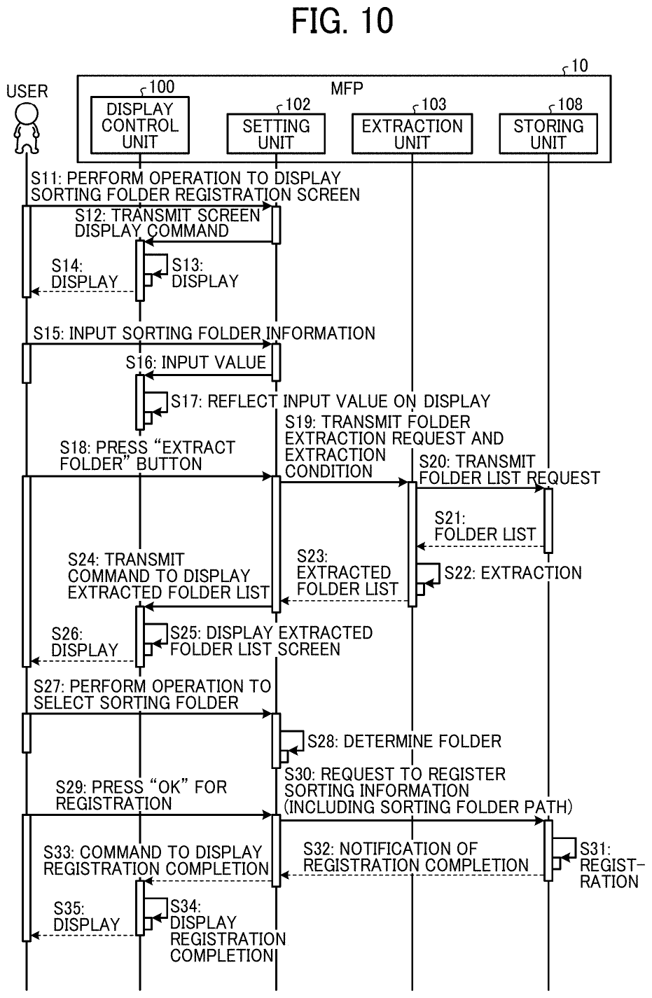

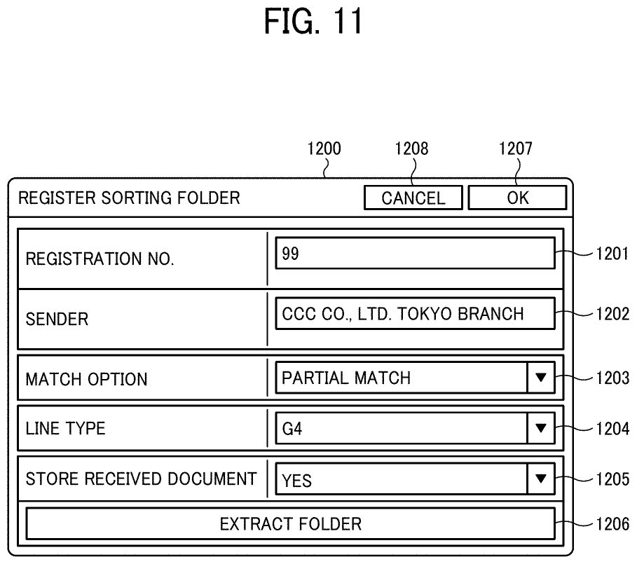

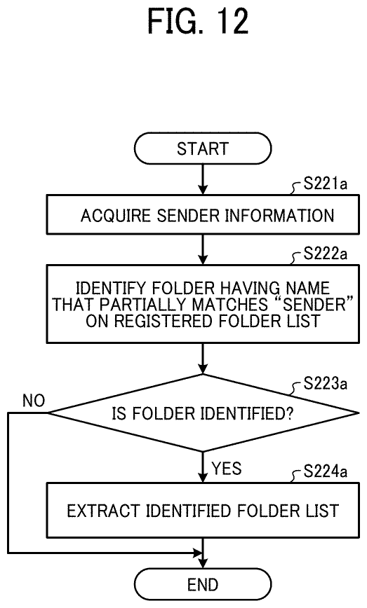

FIG. 10 is a sequence chart illustrating an example of the sorting folder setting operation performed by the MFP according to the present embodiment. FIG. 11 is a diagram illustrating an example of a sorting folder registration screen. FIG. 12 is a flowchart illustrating an example of a folder extraction operation for extracting a folder satisfying a given condition in the sorting folder setting operation. FIG. 13 is a diagram illustrating an example of the extracted folder list screen. FIG. 14 is a flowchart illustrating another example of the folder extraction operation performed in the sorting folder setting operation. FIG. 15 is a diagram illustrating another example of the extracted folder list screen. A description is given below of the sequence of the sorting folder setting operation performed by the MFP 10 according to the present embodiment, with reference to FIGS. 10 to 15.

In Step S11, the user performs an operation for displaying the sorting folder registration screen 1200 illustrated in FIG. 11 via the input unit 107.

In Step S12, the setting unit 102 of the MFP 10 transmits a command for displaying the sorting folder registration screen 1200 to the display control unit 105. In Steps S13 and 14, the display control unit 105 controls the display unit 106 to display the sorting folder registration screen 1200 according to the command.

The sorting folder registration screen 1200 illustrated in FIG. 11 is a screen for registering a sorting folder into which the facsimile data from a particular sender is sorted and stored. As illustrated in FIG. 11, the sorting folder registration screen 1200 includes a registration number input field 1201, a sender input field 1202, a match option setting field 1203, a line type setting field 1204, a storing necessity field 1205, a folder extraction button 1206, a registration button 1207 (OK button), and a cancel button 1208.

The registration number input field 1201 is a field for inputting a number (ID) uniquely identifying the record for registering the record as the sorting folder information in the sorting condition management table illustrated in FIG. 5. The sender input field 1202 is a field for inputting information (name, etc.) indicating the sender. The match option setting field 1203 is a combo box for selecting or inputting exact match or partial match as matching option for extracting a folder having a name that matches the information input in the sender input field 1202.

The line type setting field 1204 is a combo box for selecting and setting the type of line used for facsimile communication with the sender indicated by the information input by the sender input field 1202. The storing necessity field 1205 is a combo box for selecting and setting whether or not to store the facsimile data received from the sender specified by the information input by the sender input field 1202.

The folder extraction button 1206 is a button for extracting folders satisfying the extraction condition from the storing unit 108 and displaying an extracted folder list. In this example, the folder is extracted on condition that the folder name matches the information (name, etc.) input in the sender input field 1202 in the manner of match (partial match or exact match) set in the match option setting field 1203.

The registration button 1207 is a button for registering, in the sorting condition management table illustrated in FIG. 5, the information input to the above-mentioned registration number input field 1201, the sender input field 1202, the match option setting field 1203, the line type setting field 1204, the storing necessity field 1205, and the sorting folder information. The sorting folder information is the path of the folder selected as the sorting folder from the folders (listed on an extracted folder list screen 1300a illustrated in FIG. 13 or an extracted folder list screen 1300b illustrated in FIG. 15), which are extracted in response to pressing of the folder extraction button 1206.

The cancel button 1208 is a button for canceling the operation of registering the sorting folder.

In the example illustrated in FIG. 11, “99” is input in the registration number input field 1201, “CCC Co., Ltd. Tokyo branch” is input in the sender input field 1202, “partial match” is set in the match option setting field 1203, “G4” is set in the line type setting field 1204, and “Yes” set in the storing necessity field 1205.

Referring back to FIG. 10, the description of the sorting folder setting operation is continued.

In Step S15, on the sorting folder registration screen 1200 displayed on the control panel 810 by the display unit 106, the user inputs, via the input unit 107, the sorting folder information. That is, the user inputs respective information in the registration number input field 1201, the sender input field 1202, the match option setting field 1203, the line type setting field 1204, and the storing necessity field 1205.

In Step S16, the setting unit 102 transmits the values input on the sorting folder registration screen 1200 to the display control unit 105. In Step S17, the display control unit 105 reflects the input values input on the sorting folder registration screen 1200 on the display.

In Step S18, after inputting the information on the sorting folder registration screen 1200 via the input unit 107, the user presses the folder extraction button 1206. In Step S19, the setting unit 102 transmits, to the extraction unit 103, the designated extraction condition and a request to extract folders based on the designated extraction condition. The extraction conditions in this example is that the folder name matches the information (name, etc.) input in the sender input field 1202 in the manner of match (partial match or exact match) set in the match option setting field 1203.

In Steps S20 and S21, in response to a reception of the extraction condition and the folder extraction request from the setting unit 102, the extraction unit 103 of the MFP 10 transmits a request for a folder list to the storing unit 108 and receives, from the storing unit 108, a list of folders that have been created (registered) in the storing unit 108 (the auxiliary memory 808). That is, the extraction unit 103 receives a list of the folders registered in the folder management table illustrated in FIG. 4.

In Step S22, the extraction unit 103 extracts folders satisfying the extraction condition received from the setting unit 102 from all the folders in the storing unit 108. The operation of extracting folders is described in detail with reference to FIG. 12.

In Step S221a, the extraction unit 103 acquires the information (name, etc.) representing the sender, input to the sender input field 1202 of the sorting folder registration screen 1200, and the search option (that is, the match option of partial match) set in the match option setting field 1203. Then, the extraction unit 103 proceeds to Step S222a.

In Step S222a, the extraction unit 103 identifies, in the list of the folders created (registered) in the storing unit 108, folders having a name partially matching the information of the sender input in the sender input field 1202. Then, the extraction unit 103 proceeds to step S223a.

In Step S223a, when a partially matching folder(s) is identified by the extraction unit 103 (step S223a: Yes), the process proceeds to step S224a. When no matching folder is identified (step S223a: No), the folder extraction process ends.

In Step S224a, the extraction unit 103 extracts the identified folder(s) in an extraction folder list. Then, the extraction unit 103 ends the folder extraction process.

In the above-described operation illustrated in FIG. 12, the folders are extracted on condition that the folder name matches the information (name, etc.) input in the sender input field 1202 in the manner of match (partial match or exact match) set in the match option setting field 1203. However, the folder extraction condition is not limited thereto. For example, folders can be extracted on condition that the ID of the user logging in the MFP 10 matches the creator ID of the folder (that is, on condition that the user searches for the folder created by himself or herself). Such an example is described below with reference to FIG. 14.

In Step S221b, the extraction unit 103 acquires the ID of the user logging in the MFP 10. Then, the process proceeds to step S222b.

In Step S222b, the extraction unit 103 identifies, in the list of folders already created (registered) in the storing unit 108, folders each of which has a creator ID matching the user ID acquired in step S221b. Then, the extraction unit 103 proceeds to step S223b.

In Step S223b, when a matching folder(s) is identified by the extraction unit 103 (step S223b: Yes), the process proceeds to step S224b. When no matching folder is identified (step S223b: No), the folder extraction process ends.

In Step S224b, the extraction unit 103 extracts the identified folders in an extraction folder list. Then, the extraction unit 103 ends the folder extraction process.

Although two types of extraction conditions are presented in the above-described folder extraction operations illustrated in FIGS. 12 and 14, the extraction condition is not limited thereto. For example, examples of the extraction conditions include the condition that folders to be extracted are protected with a password, the condition that folders to be extracted are not yet set as the sorting folder, or the condition that folders to be extracted are empty (storing no facsimile data or no data of other type). Furthermore, such extraction conditions can be combined.

Referring back to FIG. 10, the description of the sorting folder setting operation is continued.

In Step S23, the extraction unit 103 transmits the extracted folder list to the setting unit 102 as a response to the above-mentioned folder extraction request.

In Step S24, the setting unit 102 transmits a command to display the extracted folder list received from the extraction unit 103 to the display control unit 105. In Step S25 and S26, the display control unit 105 controls the display unit 106 (the control panel 810) to display the extracted folder list screen for displaying the extracted folder list according to the command.

The extracted folder list screen 1300a in FIG. 13 presents a list of folder extracted on condition that the folder name matches the information (name, etc.) input in the sender input field 1202 in the manner of match (partial match or exact match) set in the match option setting field 1203. As illustrated in FIG. 13, the extracted folder list screen 1300a includes an extracted folder list display area 1301a, a confirmation button 1303a (an OK button), and a cancel button 1304a.

The extracted folder list display area 1301a is for displaying the extracted folder list extracted by the extraction unit 103. That is, in the extracted folder list display area 1301a, one folder named “CCC Co., Ltd. Tokyo branch” is displayed as the folder extracted on condition that the folder name partially matches “CCC Co., Ltd. Tokyo branch” input in the sender input field 1202 of the sorting folder registration screen 1200. Each folder displayed in the extracted folder list display area 1301a is provided with a radio button 1302a. The user can operate the radio button 1302a to select the folder corresponding to the radio button 1302a.

The confirmation button 1303a is a button for confirming (setting) the selected folder from the extracted folder list displayed in the extracted folder list display area 1301a as the sorting folder. The cancel button 1304a is a button for canceling the operation of setting the sorting folder.

Further, the extracted folder list screen 1300b in FIG. 15 presents a list of folders extracted on condition that the user ID of the user logging in the MFP 10 matches the folder creator ID. As illustrated in FIG. 15, the extracted folder list screen 1300b includes an extracted folder list display area 1301b, a confirmation button 1303b, and a cancel button 1304b.

The extracted folder list display area 1301b is for displaying the extracted folder list extracted by the extraction unit 103. That is, in the extracted folder list display area 1301b, three folders respectively named “CCC Co., Ltd. Tokyo branch”, “CCC Co., Ltd. Osaka branch” and “CCC Co., Ltd.,” are displayed as folders whose creator ID, specified in the list of folders created (registered) in the storing unit 108, matches the user ID (“User03” in this example) of the user logging in the MFP 10. Each folder displayed in the extracted folder list display area 1301b is provided with a radio button 1302b. The user can operate the radio button 1302b to select the folder corresponding to the radio button 1302b.

The confirmation button 1303b is a button for confirming (setting) the selected folder from the extracted folder list displayed in the extracted folder list display area 1301b as the sorting folder. The cancel button 1304b is a button for canceling the operation of setting the sorting folder.

In this way, the folders extracted under the designated extraction condition are displayed on the extracted folder list screen (for example, extracted folder list screens 1300a and 1300b), and the user can select the folder to which facsimile data is sorted from the list. Accordingly, this configuration can facilitate selection and setting of the sorting folder performed by the user.

In the above-mentioned extracted folder list screens 1300a and 1300b, only the folders extracted under the designated extraction conditions are displayed in a list, but the manner of displaying the list of folders is not limited thereto. For example, the list of folders can be displayed as follows. Of the list of folders acquired by the extraction unit 103 in steps S20 and S21, the list of folders extracted in step S22 is preferentially displayed at the upper level, and the remaining folders are displayed at the lower level. In this case as well, the folder to which the facsimile data is sorted can be easily set.

Referring back to FIG. 10, the description of the sorting folder setting operation is continued.

In Step S27, the user selects, via the input unit 107, on the extracted folder list screen (e.g., the extracted folder list screen 1300a illustrated in FIG. 13 or the extracted folder list screen 1300b illustrated in FIG. 15), a folder to which facsimile data is to be sorted, and presses the confirmation button (e.g., the confirmation button 1303a or 1303b). In Step S28, the setting unit 102 receives selecting of the folder and determines (sets) the selected folder as the sorting folder for sorting the facsimile data from the sender designated on the sorting folder registration screen 1200. Then, the display control unit 105 hides the extracted folder list screen and displays the sorting folder registration screen 1200.

In Step S29, the user presses the registration button 1207 on the sorting folder registration screen 1200 via the input unit 107. In Step S30, the setting unit 102 requests the storing unit 108 to register, as the sorting information, the information input in the registration number input field 1201, the sender input field 1202, the match option setting field 1203, the line type setting field 1204, and the storing necessity field 1205 of the sorting folder registration screen 1200, together with the information, including the path, of the determined sorting folder to which the facsimile data is sorted.

In Step S31, the storing unit 108 registers the sorting folder information received from the setting unit 102 in the sorting condition management table illustrated in FIG. 5 as a new record. Specifically, as illustrated in FIG. 5, the storing unit 108 registers, in the sorting condition management table, the information input on the sorting folder registration screen 1200. That is, the storing unit 108 registers “99” input to the registration number input field 1201 as an ID, “CCC Co., Ltd. Tokyo branch” input to the sender input field 1202 as the sender information, “partial match” input to the match option setting field 1203 as the match option, “G4” input to the line type setting field 1204 as the line type, “Yes” set in the storing necessity field 1205 set as the need for storage, and the path of the determined (set) folder as the sorting folder path in association with each other. In Step S32, in response to registration of the sorting folder information in the sorting condition management table of the storing unit 108, the setting unit 102 receives the notification that the registration is completed.

In Step S33, the setting unit 102 transmits a command to display a message or indication of completion of registration to the display control unit 105. In Steps S34 and S35, the display control unit 105 controls the display unit 106 (the control panel 810) to display the message or indication of completion of registration of the sorting folder information according to the display command.

The sorting folder setting operation is performed in the sequence of the above steps S11 to S35.

Facsimile Reception

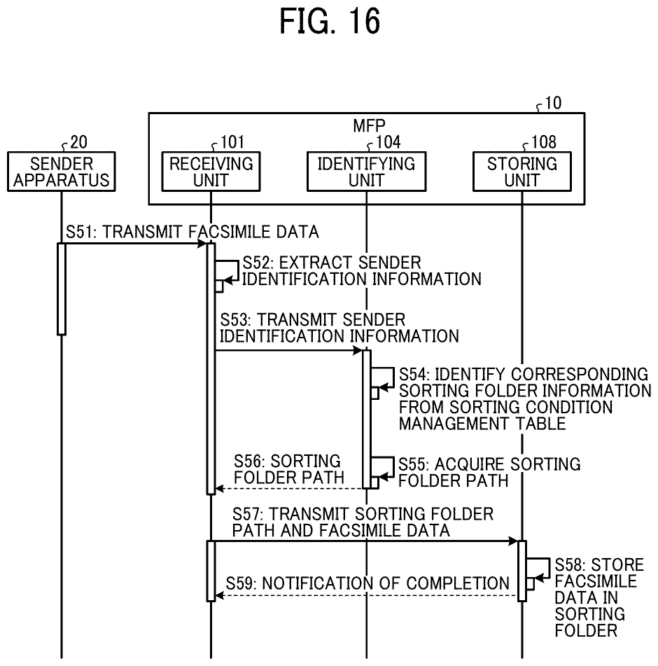

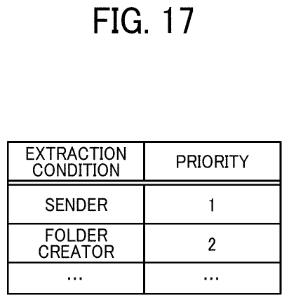

FIG. 16 is a sequence chart illustrating an example of the facsimile reception operation of the MFP according to the present embodiment. The facsimile reception operation performed by the MFP 10 according to the present embodiment will be described with reference to FIG. 16.

In Step S51, in response to transmission of facsimile data from the sender apparatus 20 at the sender, the receiving unit 101 of the MFP 10 receives the facsimile data.

In Step S52, the receiving unit 101 extracts sender identification information (for example, the facsimile number of the sender or the machine name of the sender apparatus) identifying the sender from the received facsimile data. In Step S53, the receiving unit 101 transmits the extracted sender identification information to the identifying unit 104.

In Step S54, the identifying unit 104 refers to the sorting condition management table in the storing unit 108 and identifies the sorting folder record (sorting folder information) corresponding to the received sender identification information. For example, the identifying unit 104 compares the sender information in the sorting folder record (sorting folder information) in the sorting condition management table with the sender identification information, and identifies the sorting folder record (sorting folder information). In Steps S55 and S56, the identifying unit 104 acquires the sorting folder path from the identified sorting folder record (sorting folder information), and transmits the sorting folder path to the receiving unit 101.

In Step S57, the receiving unit 101 transmits the received facsimile data and the sorting folder path received from the identifying unit 104 to the storing unit 108. In Step S58, the storing unit 108 stores facsimile data in the storage area indicated by the sorting folder path (that is, the sorting folder), and, in Step S59, transmits, to the receiving unit 101, a notification that storing is completed.

The facsimile reception operation is performed in the sequence of steps S51 to S59 described above.

As described above, in order to set the sorting folder for sorting the received facsimile data for each sender, the MFP 10 according to the present embodiment extracts, from the existing folders therein, any folder that satisfies a designated extraction condition, and displays a list of extracted folders. Extracting any folder satisfying the designated extraction condition from the existing folders in the MFP 10 is advantageous in facilitating setting of the folder to which the facsimile data is sorted.

As described above, the above-presented example extraction conditions can be combined in extracting the folders as follows. When there are a first extraction condition and a second extraction condition, for example, a list of any folder satisfying both the first extraction condition and the second extraction condition can be extracted and displayed. Alternatively, a list of folders extracted under the first extraction condition and a list of folders extracted under the second extraction condition can be displayed separately (e.g., side by side). For example, in the latter case, a display priority setting table illustrated in FIG. 17 is created in the storing unit 108 in advance, and lists of extracted folders can be displayed on the extracted folder list screen (illustrated in FIG. 13 or 15) according to the priority set in the table. In the example illustrated in FIG. 17, the extraction condition “sender” is assigned with priority “1,” and the extraction condition “folder creator” is assigned with priority “2.” The extraction condition “sender” is for extracting any folder whose folder name matches the information (name, etc.) input in the sender input field 1202 in the manner of match (partial match or exact match) set in the match option setting field 1203. The extraction condition “folder creator” is for extracting any folder created by the creator assigned with the folder creator ID matching the user ID of the user logging in the MFP 10. Therefore, for example, the display control unit 105 displays the folder extracted by the extraction condition “sender” at a higher level and the folder extracted by the extraction condition “folder creator” at a lower level on the extracted folder list screen. A folder that satisfies a plurality of extraction conditions, if any, is displayed, for example, at the top of the extracted folder list screen.

Further, the setting unit 102 may be configured to be able to preliminarily set the extraction condition to be applied. In this case, the extraction condition to be applied may be set by the setting unit 102 for each logging-in user.

According to an aspect of disclosure, an information processing apparatus includes circuitry configured to: receive facsimile data; extract, from a storage area, a folder satisfying an extraction condition; display a folder list screen including at least an extracted folder list listing the extracted folder; receive selecting of a folder from the extracted folder list; and set the selected folder as a sorting folder for storing the received facsimile data.

According to the embodiments of the present disclosure, folders satisfying a designated extraction condition can be extracted from the existing folders in an image forming apparatus, thereby facilitating setting of the folder to which the facsimile data is sorted.

Each of the functions of the above-described embodiments may be implemented by one or more processing circuits or circuitry. Here, the “processing circuit or circuitry” in the present disclosure includes a programmed processor to execute each function by software, such as a processor implemented by an electronic circuit, and devices, such as an application specific integrated circuit (ASIC), a digital signal processor (DSP), a field programmable gate array (FPGA), a system on a chip (SOC), a graphics processing unit (GPU), and conventional circuit modules arranged to perform the recited functions.

Note that, in a case where at least a portion of the functional units of the MFP 10 according to the above-described embodiment is implemented by execution of a computer program, the program can be prestored in a ROM or the like. Alternatively, the computer program executed in the MFP 10 according the above-described embodiment can be provided as a file being in an installable format or an executable format and stored in a computer-readable recording medium, such as a compact disc read only memory (CD-ROM), a flexible disk (FD), a compact disc recordable (CD-R), a digital versatile disk (DVD), and a Secure Digital (SD) card.

Further, the program executed by the MFP 10 according to the above-described embodiment may be stored on a computer connected to a network such as the Internet, to be downloaded via the network. Further, the computer program executed in the MFP 10 according the above-described embodiment may be provided or distributed via a network such as the Internet. A program to be executed by the MFP 10 according to the above-described embodiment has module structure including at least one of the above-described functional units. Regarding the actual hardware related to the program, the CPU reads and executes the program from the memory to load the program onto the main memory to implement the above-described functional units.

Any one of the above-described operations may be performed in various other ways, for example, in an order different from the one described above.

1. An image forming apparatus comprising circuitry configured to:
receive facsimile data;
extract, from a storage area, a folder satisfying an extraction condition;
display a folder list screen including at least an extracted folder list listing the extracted folder;
receive selecting of a folder from the extracted folder list; and
set the selected folder as a sorting folder for storing the received facsimile data.

2. The image forming apparatus according to claim 1,
wherein the circuitry is configured to store the received facsimile data in the set sorting folder in the storage area.

3. The image forming apparatus according to claim 2,
wherein the circuitry is configured to:
set, for each sender of facsimile data, the folder selected from the extracted folder list as the sorting folder;
extract identification information identifying a sender from the received facsimile data;
identify the sorting folder corresponding to the extracted identification information; and
store, in the identified sorting folder, the facsimile data from which the identification information is extracted.

4. The image forming apparatus according to claim 1,
wherein the circuitry is configured to display, on the folder list screen, only the extracted folder list.

5. The image forming apparatus according to claim 1,
wherein the circuitry is configured to display, on the folder list screen, the extracted folder list at a higher level and a folder list listing a rest of folders in the storage area.

6. The image forming apparatus according to claim 1,
wherein the circuitry is configured to extract, from the storage area, a folder satisfying at least two extraction conditions.

7. The image forming apparatus according to claim 1,
wherein the circuitry is configured to set the extraction condition.

8. The image forming apparatus according to claim 7,
wherein the circuitry is configured to set the extraction condition for each user logging in the image forming apparatus.

9. An information processing method comprising:
receiving facsimile data;
extracting, from a storage area, a folder satisfying an extraction condition;
displaying a folder list screen including at least an extracted folder list listing the extracted folder;
receiving selecting of a folder from the extracted folder list; and
setting the selected folder as a sorting folder for storing the received facsimile data.

10. The information processing method according to claim 9, further comprising storing the received facsimile data in the set sorting folder in the storage area.

11. The information processing method according to claim 10, further comprising:
setting, for each sender of facsimile data, the folder selected from the extracted folder list as the sorting folder;
extracting identification information identifying a sender from the received facsimile data;
identifying the sorting folder corresponding to the extracted identification information; and
storing, in the identified sorting folder, the facsimile data from which the identification information is extracted.

12. A non-transitory recording medium storing a plurality of program codes which, when executed by one or more processors, causes the processors to perform a method, the method comprising:
receiving facsimile data;
extracting, from a storage area, a folder satisfying an extraction condition;
displaying a folder list screen including at least an extracted folder list listing the extracted folder;
receiving selecting of a folder from the extracted folder list; and
setting the selected folder as a sorting folder for storing the received facsimile data.

13. The non-transitory recording medium according to claim 12,
wherein the method further comprises storing the received facsimile data in the set sorting folder in the storage area.

14. The non-transitory recording medium according to claim 13,
wherein the method further comprises:
setting, for each sender of facsimile data, the folder selected from the extracted folder list as the sorting folder;
extracting identification information identifying a sender from the received facsimile data;
identifying the sorting folder corresponding to the extracted identification information; and
storing, in the identified sorting folder, the facsimile data from which the identification information is extracted.
